(19) United States
(12) Patent Application Publication
(10) Pub. No.: US 2009/0001685 A1
(43) Pub. Date: Jan. 1, 2009

(54) BICYCLE FRAME

(75) Inventors: Jan Talavasek, Morgan Hill, CA (US); Jason L. Chamberlain, Morgan Hill, CA (US)

Correspondence Address: KNOBBE MARTENS OLSON & BEAR LLP, 2040 MAIN STREET, FOURTEENTH FLOOR, IRVINE, CA, 92614, US

(73) Assignee: Specialized Bicycle Components, Inc., Morgan Hill, CA (US)

(21) Appl. No.: 11/771,592

(22) Filed: Jun. 29, 2007

(51) Int. Cl. B62K 3/02

(52) U.S. Cl. 280/281.1

(57) ABSTRACT

A bicycle frame that includes a mainframe portion is disclosed. The mainframe portion includes a first tube, a second tube, and a third tube arranged to define a space therebetween. In one embodiment, the first tube is a top tube, the second tube is a down tube, and the third tube is a vertical tube. The tubes reside generally along a single plane. Each tube has a cross-section perpendicular to the plane. The cross-section of each of the tubes has a first dimension being parallel to the plane, and a second dimension being perpendicular to the plane. At least one of the tubes has a ratio of the second to first dimensions of 1.35 to 3.0.

### BACKGROUND OF THE INVENTION

1. Field of the Invention

The present invention generally relates to bicycles and, more specifically, to bicycle frames.

2. Description of the Related Art

Since the advent of bicycles in the 1880s, various configurations of bicycles have been developed as transporting and/or sporting means. Among other things, bicycles intended for sporting purposes have been actively developed as biking has gained popularity as a sport and recreational activity.

In general, bicycles include multiple components assembled together into a desired shape. Among the components, a bicycle frame forms a skeleton of a bicycle, and is configured to support a seat assembly, a pedal crank assembly, a front wheel, a rear wheel and a steering assembly. If the associated bicycle is intended for sporting use, the bicycle frame is typically adapted for such use.

Mountain or off-road bicycles are typically ridden over rough terrain. Thus, the frames need to be sufficiently strong to resist shocks in various directions during riding.

### SUMMARY OF THE INVENTION

An embodiment is a bicycle frame comprising a mainframe portion. The mainframe portion comprises a first tube, a second tube, and a third tube arranged to define a space therebetween. The tubes reside generally along a single plane. Each tube has a cross-section perpendicular to the plane. The cross-section of each of the tubes has a first dimension being parallel to the plane, and a second dimension being perpendicular to the plane. At least one of the tubes has a ratio of the second to first dimensions within 1.35 to 3.0.

Another embodiment is a bicycle frame comprising a mainframe portion which comprises a first tube, a second tube, and a third tube arranged to define a space therebetween. The tubes reside generally along a single plane. Each tube has a cross-section perpendicular to the plane. The cross-section of each of the tubes has a first dimension being parallel to the plane, and a second dimension being perpendicular to the plane. At least one of the tubes has a substantially constant cross-section along a majority of a total length of the tube. The substantially constant cross-section of the tube has a ratio of the second to first dimensions within 1.35 to 3.0.

Yet another embodiment is a bicycle frame comprising a plurality of tubes interconnected to one another. The tubes reside generally along a plane. Each tube has a cross-sectional height parallel to the plane, and a cross-sectional width perpendicular to the plane. At least one of the tubes has a ratio of the cross-sectional width to the cross-sectional height within 1.35 to 3.0.

Another embodiment is a bicycle comprising a front wheel, a rear wheel, and a frame assembly. The frame assembly comprises a mainframe and a subframe moveable relative to the mainframe and configured to carry the rear wheel. The mainframe comprises a top tube, a down tube, and a vertical tube arranged to define a space therebetween. The tubes reside generally along a single plane. Each tube has a cross-section perpendicular to the plane. The cross-section of each of the tubes has a first dimension being parallel to the plane, and a second dimension being perpendicular to the plane. At least one of the tubes has a ratio of the second to first dimensions within 1.35 to 3.0.

For purposes of summarizing the invention and the advantages achieved over the prior art, certain objects and advantages of the invention have been described above and as further described below. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 is a side elevational view of an off-road bicycle, or mountain bike, incorporating a frame according to one embodiment;

FIG. 2 is a side elevational view of the bicycle frame of FIG. 1 with certain components of the bicycle removed for clarity;

FIG. 3 is a partial perspective view of the top tube of the bicycle frame of FIG. 2;

FIG. 4 is a side elevational view of the bicycle frame of FIG. 2;

FIG. 5 is a partial side elevational view of the bicycle frame of FIG. 2 illustrating the configuration of a gusset; and

FIG. 6 is a top plan view of the bicycle frame of FIG. 2.

### DETAILED DESCRIPTION OF THE PREFERRED EMBODIMENT

With respect to mountain or off-road bicycles, frames need to be sufficiently strong to resist shocks in various directions during riding because they are ridden over rough terrain. In addition, it is often desirable that the frames have a lightweight. The frames also need to provide a low standover height to provide riders with comfort and safety. In addition, the frames need to provide a space for carrying water bottles for use during riding. Thus, a need exists for a lightweight bicycle frame that is structurally strong enough to resist shock while providing a low standover height as well as a space for water bottles.

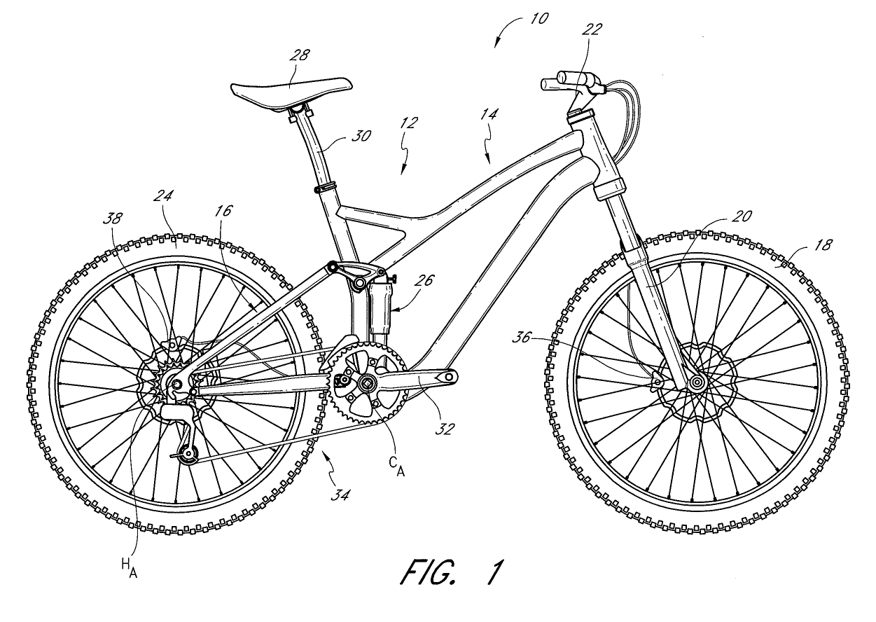

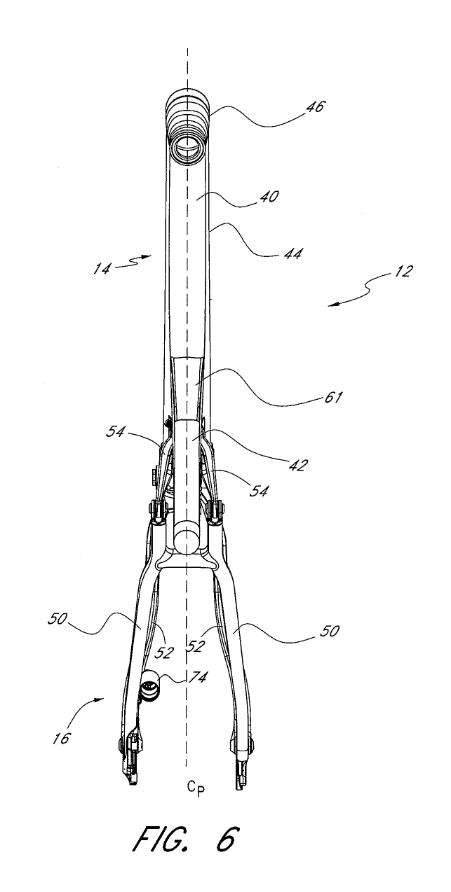

FIG. 1 illustrates an off-road bicycle, or mountain bike 10, including an embodiment of a bicycle frame (or frame assembly). The bicycle 10 is described herein with reference to a coordinate system wherein a longitudinal axis extends from a forward end to a rearward end of the bicycle 10. A vertical, central plane Cp (FIG. 6) generally bisects the bicycle 10 and contains the longitudinal axis. A lateral axis extends normal to the longitudinal axis and within a horizontal plane. In addition, relative heights are generally expressed as elevations in reference to a horizontal surface on which the bicycle 10 is supported in an upright position. Similarly, relative forward and rearward positions are expressed as distances in reference to a vertical axis, which is normal to the horizontal surface. The above-described coordinate system is provided for the convenience of describing the embodiment illustrated in FIGS. 1-6, and is not intended to limit the scope of the invention unless expressly stated otherwise.

The bicycle 10 includes a frame (or frame assembly) 12 including a mainframe (or mainframe portion) 14 and a subframe (or an articulating frame portion) 16. The subframe 16 is pivotally connected to the mainframe 14, as is described in greater detail below. The details of the mainframe 14 and the subframe 16 will be described later.

The bicycle 10 also includes a front wheel 18 and a rear wheel 24. The front wheel 18 is carried by a front suspension assembly, or front fork 20. A steerer tube (not shown) is journaled for limited rotation about a steering axis defined by the mainframe 14. The fork 20 is secured to the mainframe 14 by a handlebar assembly 22, as is well known in the art. The rear wheel 24 of the bicycle 10 is carried by the subframe 16.

The bicycle 10 further includes a shock absorber 26 to provide resistance to the pivoting motion of the subframe 16 while the bicycle 10 is in use. The shock absorber 26 is pivotally connected to both the mainframe 14 and the subframe 16, and thus provides resistance to the suspension travel of the rear wheel 24.

In addition, the bicycle 10 includes a seat 28 to provide support for a rider of the bicycle 10. The seat 28 can be connected to the mainframe 14 by a seat post 30. The illustrated seat post 30 is attached to the seat 28 and received within an upstanding seat tube or vertical tube of the mainframe 14. In another embodiment, the seat post 30 can be configured to receive the seat tube therein.

The bicycle 10 also includes a pedal crank assembly 32 that is rotatably supported by the mainframe 14 and that drives a multi-speed chain drive arrangement 34, as is well known in the art. The bicycle 10 further includes front and rear brake systems 36, 38 for slowing and stopping the bicycle 10. Although the front and rear brakes 36, 38 are illustrated as disc type brakes, rim type brakes may be alternatively provided, as will be appreciated by one of skill in the art. Rider controls (not shown) are commonly provided on the handlebar assembly 22 and are operable to control shifting of the multi-speed chain drive arrangement 34 and front and rear brake systems 36, 38.

### Bicycle Frame

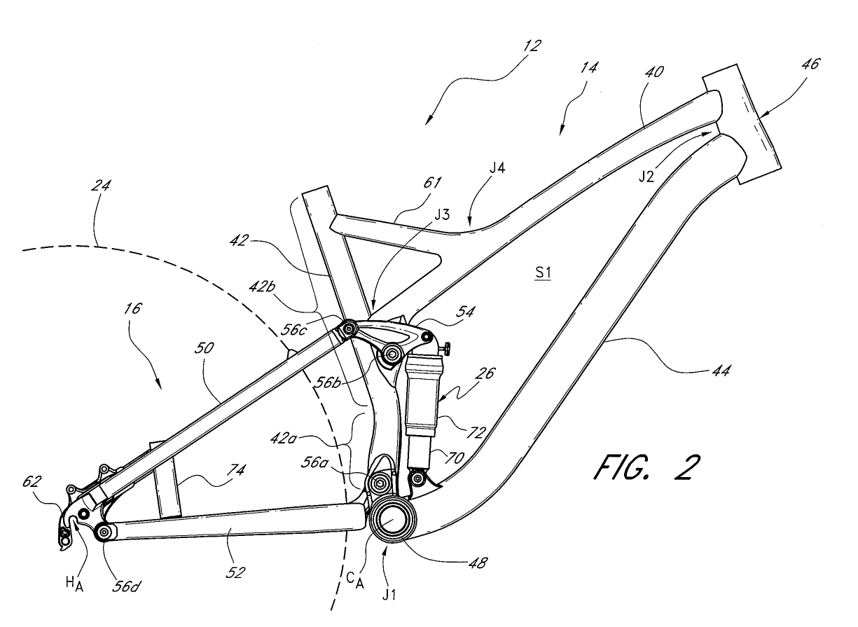

With reference to FIGS. 2-6, the bicycle frame 12 is illustrated with the remaining components of the bicycle 10 removed for clarity. The bicycle frame 12 can include a mainframe 14, a subframe 16, and a shock absorber 26. The subframe 16 and the shock absorber 26 together form a suspension assembly. As set forth above, the subframe 16 is pivotally connected to the mainframe 14, and supports the rear wheel 24 of the bicycle 10. The subframe 16 is configured to allow the rear wheel 24 to move generally vertically from a first, i.e., extended or relaxed, position of the subframe 16 to a second, or compressed, position of the subframe 16. This motion permits the rear wheel 24 and the suspension assembly to absorb bumps that may be encountered during use of the bicycle 10.

Both the mainframe 14 and the subframe 16 may be constructed from tubular pieces of composites (e.g., carbon fiber). This configuration permits the bicycle frame 12 to have a lightweight. However, other suitable materials, such as metal (e.g., aluminum or steel), may also be used. The individual tubes may be joined by any suitable process, such as welding, brazing, or bonding, for example. Alternatively, all or a portion of the mainframe 14 and/or subframe 16 may be a unitary structure.

Mainframe

With reference to FIG. 2, the illustrated mainframe 14 includes a top tube 40, a seat tube (or vertical tube) 42, a down tube 44, and a head tube 46. The mainframe 14 may also include a bottom bracket shell 48 and a gusset 61. The top tube 40, the seat tube 42, the down tube 44, and the head tube 46 preferably reside generally along a single plane, and are preferably connected to define a space S1 between them. In the illustrated embodiment, the seat tube 42 and the down tube 44 are connected to each other at a first junction J1. The top tube 40 and the down tube 44 are connected to each other via the head tube 46 which generally forms a second junction J2. In other embodiments, the top tube 40 and the down tube 44 may be connected directly to each other. The top tube 40 and the seat tube 42 are connected to each other at a third junction J3.

The top tube 40 preferably extends generally upward and forward from the seat tube 42 and connects to the head tube 46. In the illustrated embodiment, the top tube 40 is connected to approximately the midpoint of the length of the seat tube 42. It will, however, be appreciated that the top tube 40 can be connected to other portions of the seat tube 42 depending on the design of the bicycle frame.

The seat tube 42 extends generally in a vertical direction from the down tube 44. A portion of the seat tube 42 is connected to a rearward end of the top tube 40. The illustrated seat tube 42 includes an upright portion 42a extending generally in an upward direction from the first junction J1. The seat tube 42 also includes a skewing portion 42b slightly skewed in a rearward direction from the upright portion 42a as it extends toward the third junction J3. The seat tube 42 extends upwards from the top tube 40 and supports the seat post 30 (FIG. 1). The length of the seat tube 42 extending above the top tube 40 may vary according to frame size. Alternatively, or additionally, the seat tube 42 may be shaped, i.e., deformed into a non-circular cross-section, to increase the tube's resistance to bending or torsion, as will be appreciated by one of skill in the art.

The illustrated down tube 44 is below the top tube 40, extending generally upward and forward from the first junction J1 and connecting to the head tube 46. In certain embodiments, at least one end of at least one of the top and down tubes 40, 44 can flare (i.e., increase in cross-section) toward another tube to which it is coupled for making a firm connection thereto.

The illustrated head tube 46 extends upward from its connection to the down tube 44, and is preferably slightly skewed in a rearward direction. The illustrated head tube 46 extends substantially parallel to the skewing portion 42b of the seat tube 42. The head tube 46 rotatably supports a steerer tube (not shown) of the front fork 20 (FIG. 1).

A bottom bracket shell 48 preferably is provided at the first junction J between the seat tube 42 and the down tube 44. The bottom bracket shell 48 rotatably supports the pedal crank assembly 32, as described above in relation to FIG. 1, in a manner well known in the art.

The gusset 61 preferably extends in an upper rearward direction from the top tube 40. The gusset 61 preferably connects to both the top tube 40 and the seat tube 42. The gusset 61 serves to provide additional support to the portion of the seat tube 42 extending above the top tube 40.

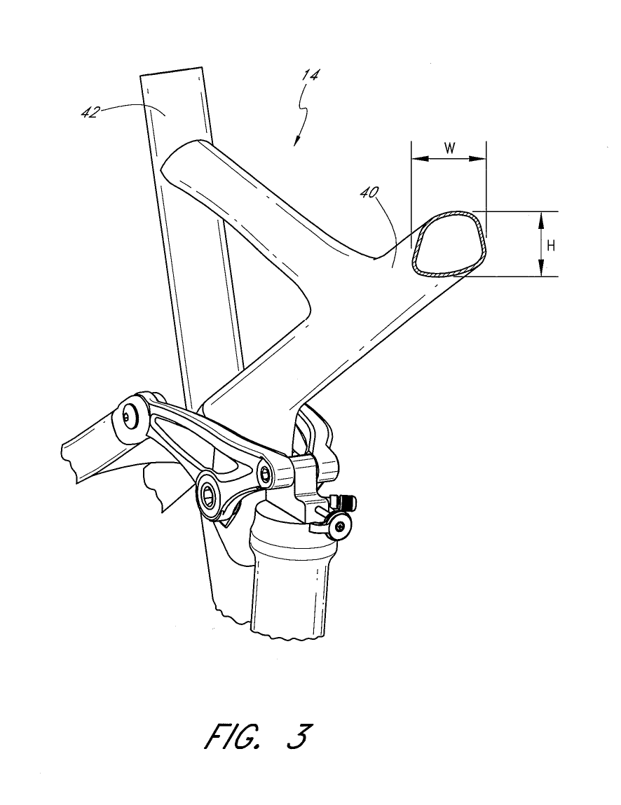

With reference to FIG. 3, the configuration of the top tube 40 will be described below. In FIG. 3, a portion of the top tube 40 is shown with a cross-section thereof. The illustrated cross-section of the top tube 40 is perpendicular to a plane along which the top tube 40, the seat tube 42, and the down tube 44 reside. The cross-section of the top tube 40 has a first dimension H parallel to the plane, and a second dimension W perpendicular to the plane. The first dimension H can also be referred to as a “cross-sectional height” in the context of this document, in which the aforementioned plane is vertical. The second dimension W can also be referred to as a “cross-sectional width” in the context of this document.

In one embodiment, the top tube 40 has a substantially constant cross-section along the majority of the length of the top tube 40. The substantially constant cross-section of the top tube 40 preferably has a ratio of the second (W) to first (H) dimensions (e.g., width to height) of 1.35 to about 3.0, more preferably about 1.45 to about 3.0, and most preferably, about 1.50 to about 1.70. For example, the ratio may be 1.35, 1.36, 1.37, 1.38, 1.39, 1.40, 1.41, 1.42, 1.43, 1.44, 1.45, 1.46, 1.47, 1.48, 1.49, 1.50, 1.51, 1.52, 1.53, 1.54, 1.55, 1.56, 1.57, 1.58, 1.59, 1.60, 1.61, 1.62, 1.63, 1.64, 1.65, 1.66, 1.67, 1.68, 1.69, 1.70, 1.71, 1.72, 1.73, 1.74, 1.75, 1.76, 1.77, 1.78, 1.79, 1.80, 1.81, 1.82, 1.83, 1.84, 1.85, 1.86, 1.87, 1.88, 1.89, 1.90, 1.91, 1.92, 1.93, 1.94, 1.95, 1.96, 1.97, 1.98, 1.99, 2.00, 2.05, 2.10, 2.15, 2.20, 2.25, 2.30, 2.35, 2.40, 2.45, 2.50, 2.55, 2.60, 2.65, 2.70, 2.75, 2.80, 2.85, 2.90, 2.95, 3.00 or within a range of ratios between any two of the foregoing values. The foregoing cross-sectional width-to-height ratios permit a reduced standover height without adversely affecting the mechanical strength (e.g., resistance to vertical bending) of the top tube 40. The term “standover height” refers to a distance from the ground to the top of the top tube 40 at its midpoint between the seat tube 42 and the head tube 46. Alternatively, the term “standover height” may refer to a distance from the ground to the top of the rearward end of the top tube 40. A ratio of less than 1.35 may provide an undesirable standover height whereas a ratio of above 3.0 may cause the tube 40 to be too wide, and thereby, cause rubbing against legs (inner thighs) during the pedal stroke, or may reduce resistance to vertical bending.

In one embodiment, the first dimension H of the cross-section of the top tube 40 is at least about 20 mm, preferably between about 20 mm and about 45 mm. The second dimension W of the cross-section of the top tube 40 is preferably no greater than 60 mm, preferably between about 27 mm and about 60 mm. One or both of the ends of the top tube 40 may also have a flaring portion, i.e., a portion of increased cross-section, which may improve the strength of connection to another tube. Accordingly, the flaring portion(s) may not have the ratio and the dimensions described above. A skilled artisan will appreciate that the first and second dimensions can vary depending on the design of the top tube while meeting the ratio set forth above.

In another embodiment, the top tube 40 can have a varying cross-section along the length of the top tube 40. The varying cross-section can have a ratio of the second to first dimensions (width to height) of 1.35 to about 3.0 along the length of the top tube 40. In this embodiment, the first dimension H of the cross-section of the top tube 40 is preferably at least about 20 mm, preferably between about 20 mm and about 45 mm. The second dimension W of the cross-section of the top tube 40 is preferably no greater than 60 mm, preferably between about 27 mm and about 60 mm.

In yet another embodiment, the down tube 44 can have a cross-section having a width-to-height ratio of 1.35 to about 3.0. In another embodiment, the seat tube 42 can have a cross-section having a width-to-height ratio of 1.35 to about 3.0. In certain embodiments, any two or all of the top tube 40, the seat tube 42, and the down tube 44 can have a width-to-height ratio of 1.35 to about 3.0. In other embodiments, tubes other than the top tube 40, the seat tube 42, and the down tube 44 can also have one of the aforementioned ratios.

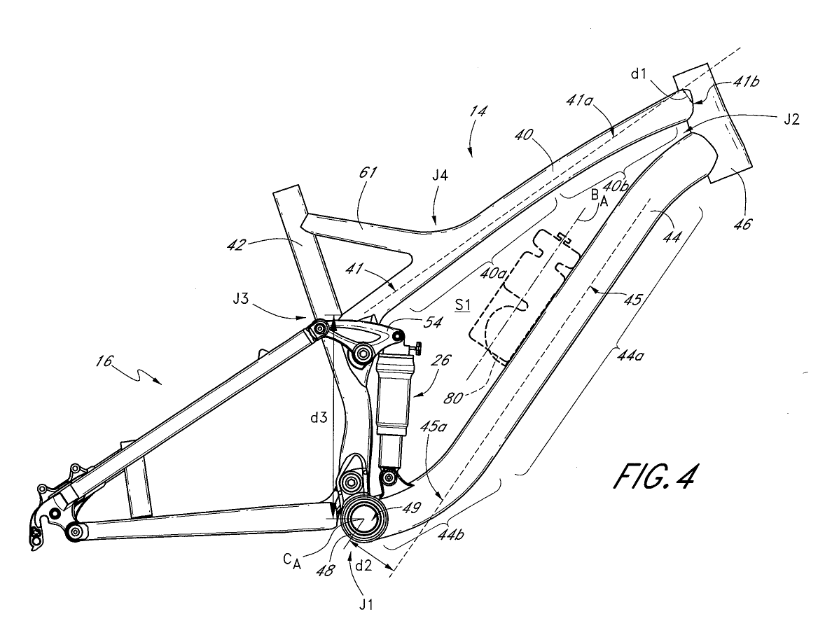

With reference to FIG. 4, the shapes of the top tube 40 and the down tube 44 will be described. At least one of the top tube 40 and the down tube 44 can include a curved portion at, for example, at least one of the end portions thereof. This configuration provides room for mounting a water bottle 80 on the down tube 44 such that the water bottle 80 is accommodated within the space S1 between the top tube 40 and the down tube 44.

In the illustrated embodiment, the top tube 40 includes a substantially straight portion 40a and a curved portion 40b. The substantially straight portion 40a extends from the third junction J3 between the top tube 40 and the seat tube 42. The curved portion 40b extends from the substantially straight portion 40a and connects to the head tube 46. The curved portion 40b preferably bends downward toward the down tube 44 as it extends toward the head tube 46. The substantially straight portion 40a has a longitudinal axis 41 extending therethrough. In FIG. 4, an imaginary straight line 41a extends colinearly from the longitudinal axis 41 toward the head tube 46. In addition, the top tube 40 has a cross-section at a junction between the top tube 40 and the head tube 46. The cross-section has a center 41b. In one embodiment, a distance d1 between the center 41b of the cross-section of the top tube 40 at the junction and the closest point of the imaginary straight line 41a is between about 15 mm and about 35 mm, and preferably between about 25 mm and about 30 mm. For example, the distance d1 can be 15, 16, 17, 18, 19, 20, 21, 22, 23, 24, 25, 26, 27, 28, 29, 30, 31, 32, 33, 34, 35 mm, or within a range of lengths between any two of the foregoing values. The distance d1 is measured along another imaginary line extending perpendicular to the imaginary line 41a from the center 41b of the cross-section of the top tube 40 at the junction.

A skilled artisan will appreciate that the top tube 40 can be curved along the majority of the length of the top tube 40 to provide room for mounting a water bottle 80, as will be better understood from the description below. In addition, a skilled artisan will appreciate that the top tube 40 can have various shapes as long as it can provide such room for a water bottle 80.

Similarly, the down tube 44 preferably includes a substantially straight portion 44a and a curved portion 44b. The substantially straight portion 44a forms a majority of the total length of the down tube 44. For example, the substantially straight portion 44a may form at least about one quarter (¼) of the total length of the down tube 44. The curved portion 44b extends from the substantially straight portion 44a and connects to the seat tube 42. The curved portion 44b preferably bends generally rearward and upward toward the top tube 40 as it extends toward the seat tube 42. The substantially straight portion 44a has a longitudinal axis 45 extending therethrough. In FIG. 4, an imaginary straight line 45a extends colinearly from the longitudinal axis 45. The bottom bracket shell 48 has a through-hole 49 extending perpendicular to the plane along which the tubes 40, 42, 44 reside. The through-hole 49 has a bracket axis C_{A} extending through the center thereof. In one embodiment, a distance d2 between the bracket axis C_{A} and the closest point of the imaginary straight line 45a is between about 20 mm and about 100 mm, preferably between about 40 mm and about 80 mm, and more preferably between about 50 mm and 70 mm. The distance d2 can be 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 mm, or within a range of lengths between any two of the foregoing values. The distance d2 is measured along another imaginary line extending perpendicular to the imaginary line 45a from the bracket axis C_{A}.

A skilled artisan will appreciate that the down tube 44 can be curved along the majority of the length of the down tube 44 to provide room for mounting a water bottle 80, as will be better understood from the description below. In addition, a skilled artisan will appreciate that the down tube 44 can have various shapes as long as it can provide such room for a water bottle 80.

In the embodiments described above, the mainframe 14 can have a relatively short distance between the top tube 40 and the down tube 44. In one embodiment, a distance d3 between the top surface of the top tube 40 at the third junction J3 and the bottom bracket axis C_{A} is between about 240 mm and about 270 mm, and preferably about 250 mm. This distance d3 can be referred to as a “frame height” in the context of this document. The configurations of the top tube 40 and the down tube 44, particularly, a relatively high cross-sectional width-to-height ratio of the top tube 40 and the shapes of the top and down tubes 40, 44, permit such a relatively short distance between the top tube 40 and the down tube 44.

The mainframe 14 preferably provides space for mounting a water bottle 80 and optionally a shock absorber 26. In the embodiments described above, the cross-sectional width-to-height ratio of at least one of the top and down tubes 40, 44 can be relatively high. In other words, at least one of the tubes 40, 44 can have a relatively short height compared to its width. Thus, the mainframe 14 can have more space between the tubes 40, 44 compared to a bicycle frame having the same frame height with thicker top and down tubes. In addition, the curved shapes of the top and down tubes 40, 44 further provide room for mounting a water bottle 80 and optionally a shock absorber 26. The details of the shock absorber 26 will be described later in connection with the subframe 16.

In the illustrated embodiment, a water bottle mount may be provided on the down tube 44, so that a bottle cage for holding a water bottle 80 may be mounted thereto, as illustrated in phantom in FIG. 4. The placement of the water bottle 80 within the space created by the mainframe 14 permits convenient access to a water bottle 80. In another embodiment, a second water bottle mount may further be provided at any suitable location, e.g., the underside of the top tube 40 or down tube 44.

As is conventional, a preferred water bottle mount commonly includes a pair of threaded apertures spaced axially from one another within one side wall of a tube member of the mainframe 14. Threaded fasteners are used to mount a bottle holder, or cage, to the mainframe 14. The bottle cage is typically constructed from bent metal wire or tubing and is configured to support a water bottle 80 substantially parallel to the longitudinal axis 45 of the down tube 44 of the mainframe 14 in the embodiment of FIG. 4.

In the illustrated embodiment, a preferred bottle cage permits a water bottle 80 to be placed into or removed from the cage by a sliding motion along an axis B_{A}, which is substantially parallel to the longitudinal axis 45 of the down tube 44 to which the cage is mounted. Thus, ample room within the space S1 of the mainframe 14 is often necessary to be able to slide the water bottle 80 along the axis B_{A} until it is removed from the cage. Such a cage is preferred because of its low weight and ability to securely hold a water bottle 80, even when the bicycle 10 is ridden over rough terrain. In another embodiment, more complex cages that permit use in smaller areas, such as cages that pivot sideways relative to the mainframe 14, can also be adapted for use with the mainframe 14. In one embodiment, the water bottle 80 can have a generally cylindrical shape. A cylindrical water bottle 80 may have a length between about 150 mm and about 300 mm, and a diameter between about 70 mm and about 80 mm.

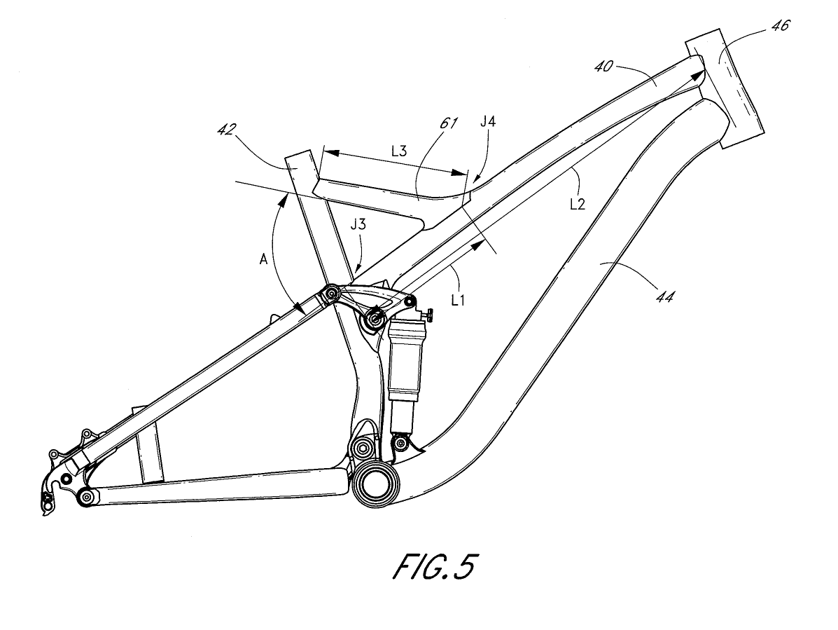

With reference to FIG. 5, the configuration of the gusset 61 is now described. In the illustrated embodiment, the gusset 61 extends in an upper rearward direction from the top tube 40 to the seat tube 42 to provide additional support to the portion of the seat tube 42 extending above the top tube 40. The gusset 61 is connected to the top tube 40 at a fourth junction J4. A distance L1 between the third junction J3 (between the top tube 40 and the seat tube 42) and the fourth junction J4 is about 20% to about 40% of the total length L2 of the top tube 40, preferably about 30% to about 35% of the total length L2 of the top tube 40. The gusset 61 can have a length L3 of about 20% to about 40% of the total length L2 of the top tube 40. The gusset 61 and the top tube 40 may form an angle A of about 30° to about 55° with each other, preferably about 35° to about 50°, and more preferably, about 40° to about 50°.

In the embodiments described above, the bicycle 10 preferably has a relatively short standover height. The relatively high cross-sectional width-to-height ratios and the shapes of the tubes 40, 42, 44 permit such a relatively short standover height. A short standover height allows riders to have more clearance over the top tube 40, and thus provides riders with safety and comfort. In addition, the bicycle frame 12 with a low standover height can accommodate shorter riders, who may be unable to comfortably fit on many prior art bicycles. Furthermore, the configurations of the top and down tubes 40, 44 provide room for a water bottle 80 and optionally a shock absorber 26.

Subframe and Shock Absorber

With reference to FIGS. 2 and 6, the articulating frame portion or subframe 16 includes an upper arm 50, a lower arm 52, and a link 54. The term “upper arm” can also be referred to as a “seat stay.” The term “lower arm” can also be referred to as a “chain stay.” The term “link” can also be referred to as a “rocker.” Each of the upper arm 50, the lower arm 52, and the link 54 includes a pair of arm portions, which are positioned on opposing sides of the rear wheel 24. That is, as shown in FIG. 6, the mainframe 14 lies substantially along a central, vertical plane Cp of the bicycle 10, and each of the upper arm 50, lower arm 52, and link 52 desirably includes arm portions spaced laterally on each side of the central plane Cp. Alternatively, a single-sided subframe assembly may be provided which includes arm portions on only one side of the rear wheel 24, as will be appreciated by one of skill in the art. The illustrated design is preferred, however, for superior strength, balance and low weight.

The upper arm 50 preferably extends generally rearward and downward from the seat tube 42. An upper (or front) end of the upper arm 50 is preferably pivotally connected to the link 54. A lower (or rear) end of the upper arm 50 is preferably pivotally connected to a rearward end of the lower arm 52. The term “pivotally” referred to here indicates a pivotal movement about a horizontal axis.

The lower arm 52 extends forward from the lower end of the upper arm 50 and connects pivotally to the mainframe 14. In the illustrated embodiment, a forward end of the lower arm 52 is connected pivotally to a lower portion of the seat tube 42 near the first junction J1 between the seat tube 42 and the down tube 44 above the bottom bracket shell 48.

The link 54 is also pivotally connected to the mainframe 14 near the third junction J3 between the top tube 40 and the seat tube 42. The link 54 serves to provide the upper arm 50 with a pivotal movement when the bicycle is in use.

As described above, the mainframe 14, the upper arm 50, the lower arm 52, and the link 54 are interconnected by a plurality of pivotal connections, generally referred to by the reference numeral 56. The locations of the pivots 56 and the relative lengths and relative angles of the upper arm 50, the lower arm 52, and the link 54 can be selected to isolate pedal-induced and brake-induced forces from causing unwanted pivoting motion of the subframe 16.

Preferably, the pivot 56a between the lower arm 52 and the mainframe 14 is located above the bottom bracket shell 48. The pivot 56b between the link 54 and the mainframe 14 is desirably located on or near the third junction J3 between the top tube 40 and the seat tube 42. The third junction J3 provides an advantageous location to mount the subframe 16 and, specifically, the link 54 at least partly because the mainframe 14 has heightened strength and rigidity at the third junction J3. Accordingly, the entire bicycle frame 12 is strong and laterally rigid without requiring the arms 50, 52 or link 54 of the subframe 16 to be made larger or thicker. As a result, the entire frame 12 can be relatively lightweight, while remaining desirably strong. A pivotal connection 56c between a rear end of the link 54 and the upper end of the upper arm 50 is desirably positioned above the pivot 56b between the link 54 and the mainframe 14. That is, the pivot 56c preferably is located vertically higher than the pivot 56b when the subframe 16 is in its relaxed, or extended position.

A pivotal connection 56d between the upper arm 50 and the lower arm 52 is desirably positioned below a dropout 62 formed on the lower end of the upper arm 50. The dropout 62 supports an axle (not shown) of the rear wheel 24, as is known in the art. The axle of the rear wheel 24 defines an axis of rotation of the rear wheel 24, or a hub axis H_{A}. Accordingly, the hub axis H_{A} desirably is located above the pivotal connection 56d. Desirably, the pivotal connection 56d is located at or near one of the rearward end of the lower arm 52 and the lower end of the upper arm 50. Preferably, the connection 56d is less than about five inches and, more preferably, less than about two inches from one of the rearward end of the lower arm 52 and the lower end of the upper arm 50.

The above-described pivot locations have been found to advantageously isolate pedal-induced and brake-induced forces from being transmitted to the subframe 16 of the bicycle 10. As such, these pivot locations are preferred locations. In addition, it is preferred that an imaginary line extending between the pivots 56a and 56d crosses an imaginary line extending between the hub axis H_{A} and the crank axis C_{A}. Alternatively, other relative lengths and angles of the subframe 16 members and/or other pivot locations may also be used. For example, the pivot 56a between the mainframe 14 and the lower arm 52 may alternatively be positioned below, or concentric with, the crank axis C_{A}. In addition, the pivot 56d between the lower arm 52 and the upper arm 50 may alternatively be positioned above the hub axis H_{A}, resulting in the rear wheel 24 being carried by the lower arm 52. Also, the link 54 may be longer than the illustrated embodiment, and may even be approximately the same length as the lower arm 52, such that the upper arm 50 is held in an approximately vertical orientation. In addition, other modifications apparent to one of skill in the art may also be incorporated.

Desirably, one or more bearing assemblies are provided at each pivot 56 to permit smooth pivoting motion of the rear suspension. Alternatively, bushings or other suitable constructions may also be used, as may be determined by one of skill in the art.

As mentioned above, the shock absorber 26 is preferably operably positioned between the subframe 16 and the mainframe 14 to provide resistance to articulating movement of the subframe 16, and thus the rear wheel 24. Preferably, an upper end of the shock absorber 26 is pivotally connected to the third junction J3 of the mainframe 14 via the link 54. A lower end of the shock absorber 26 can be pivotally connected to a rearward end portion of the down tube 44. In another embodiment, the upper end of the shock absorber 26 may be connected directly to a member of the subframe 16, other than the link 54. A skilled artisan will appreciate that the shock absorber 26 can be positioned at any other suitable location in any suitable orientation.

The illustrated shock absorber 26 has a main shock body including a shock shaft portion 70 telescopingly engaged with a shock body portion 72. Desirably the shock absorber 26 provides both a spring force and a damping force, as is known in the art. The spring force is related to the relative position between the shock shaft 70 and the shock body 72 while the damping force is related to the relative speed between the shock shaft 70 and the shock body 72. The spring assembly may include an air spring assembly, a coil spring assembly, or other suitable suspension springs, as may be determined by one of skill in the art. In addition, the shock absorber 26 may be mounted in a reverse orientation from the illustrated embodiment. That is, the shock shaft 70 may be connected to the link 54 and the shock body 72 may be connected to the down tube 44, as will be appreciated by one of skill in the art.

As mentioned above, the subframe 16 pivots with respect to the mainframe 14 to move the rear wheel 24 along a wheel travel path. As will be appreciated by one of skill in the art, the travel path of the rear wheel 24 may be linear, curvilinear, or arcuate. The travel path defines a distance from the relaxed position of the subframe 16 to the compressed position of the subframe 16. Preferably, the shock absorber 26 has from about one and one-half to two and one-half inches of travel and, more preferably, about one and three-quarters to two inches of travel. In addition, the average ratio of rear wheel 24 travel to shock absorber 26 travel desirably is less than about 2.6:1, preferably less than about 2:1 and more preferably about 1.8:1. In addition, the shock absorber 26 positioned along the seat tube 42 effectively minimizes vertical impact exerted on the bicycle frame 12 when the bicycle is in use. The position of the shock absorber 26 also contributes to the reinforcement of the frame structure.

The illustrated shock absorber 26 includes a fluid cylinder and a piston movable within the fluid cylinder. The piston preferably forces hydraulic fluid within the fluid cylinder through one or more restrictive flow paths to generate a damping force when the shock absorber 26 is both extending and compressing, as is known in the art. One or more flow paths may be provided for each or both of extending motion and compressing motion of the shock absorber 26. In addition, the restriction of one or more of the flow paths may be externally adjustable to permit adjustment of the damping force provided by the shock absorber 26.

Desirably, the fluid cylinder within the shock absorber 26 is connected to a reservoir chamber defined within a reservoir 74 of the shock absorber 26. The illustrated reservoir 74 is remotely connected to the shock absorber 26 by a hydraulic hose connection. The reservoir 74 is mounted on the lower arm 52 of the subframe 16 while extending toward the upper arm 50 across the space between the upper arm 50 and the lower arm 52. In other embodiments, the reservoir can be mounted on the lower arm 52 of the subframe 16 in a different orientation. In certain embodiments, the reservoir can be mounted on the upper arm 50 of the subframe 16.

Referring to FIG. 6, when viewed from above, the reservoir 74 is positioned between two opposing portions of the subframe 16. The reservoir 74 is preferably immediately adjacent to the left (or right) side portion of the subframe 16 to permit adequate clearance for the rear wheel 24 of the bicycle 10 between the reservoir 74 and the right (or left) side portion of the subframe 16. By positioning the reservoir 74 between the two portions of the subframe 16, the reservoir 74 is substantially protected from damage.

Desirably, an inertia valve arrangement is operably positioned between the fluid cylinder of the shock absorber 26 and the fluid chamber of the reservoir 74, and is arranged to selectively alter the damping force provided by the shock absorber 26. As will be appreciated by one of skill in the art, an inertia valve assembly commonly includes an inertia mass biased into a closed position, i.e., covering one or more fluid ports, by a biasing member, such as a coil spring.

When an acceleration force acting on the shock absorber 26, along the direction of movement of the inertia mass, exceeds a predetermined threshold, the inertia mass opens against the biasing force of the spring to uncover the fluid ports. Hydraulic fluid is permitted to flow through the opened fluid ports, thereby increasing the total fluid flow within the shock absorber 26 and reducing the damping force. In the illustrated embodiment, the inertia valve preferably remains closed in response to accelerations originating at the sprung mass (i.e., the mainframe 14 and rider of the bicycle 10) and opens in response to accelerations above a predetermined threshold, which originate at the unsprung mass (i.e., the subframe 16 and rear wheel 24 of the bicycle 10). An exemplary shock absorber incorporating an inertia valve arrangement is described in U.S. Pat. No. 6,267,400, the entirety of which is incorporated herein by reference.

In the illustrated embodiment, the top tube 40 and the seat tube 42 are coupled to each other at the third junction J3. In addition, the upper arm 50 is preferably pivotally connected to the mainframe portion 14 near the third junction J3 via the link 54. The location of the interconnection of the top tube 40, the seat tube 42, and the upper arm 50 reinforces the structure of the mainframe 14. The location of the connection between the top tube 40 and the seat tube 42 relative to the location of the pivot 56b desirably remains substantially constant for all the different sizes of the bicycle frame 12.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while the number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with, or substituted for, one another in order to perform varying modes of the disclosed invention. Thus, it is intended that the scope of the present invention herein disclosed should not be limited by the particular disclosed embodiments described above, but should be determined only by a fair reading of the claims.

What is claimed is:

1. A bicycle frame comprising:
a mainframe portion comprising a first tube, a second tube, and a third tube arranged to define a space therebetween,
wherein the tubes reside generally along a single plane, each tube having a cross-section perpendicular to the plane,
wherein the cross-section of each of the tubes has a first dimension being parallel to the plane, and a second dimension being perpendicular to the plane, and
wherein at least one of the tubes has a ratio of the second to first dimensions within 1.35 to 3.0.

2. The bicycle frame of claim 1, wherein the ratio of the second to first dimensions is within 1.45 to 3.0.

3. The bicycle frame of claim 1, wherein the first tube is a top tube, the second tube is a down tube, and the third tube is a vertical tube.

4. The bicycle frame of claim 3, wherein the first dimension of the top tube is at least 20 mm.

5. The bicycle frame of claim 3, wherein the second dimension of the top tube is no greater than 60 mm.

6. The bicycle frame of claim 3, wherein said at least one of the tubes includes the top tube.

7. The bicycle frame of claim 6, wherein the top tube has a substantially constant cross-section along a majority of a total length of the top tube.

8. The bicycle frame of claim 7, wherein the substantially constant cross-section of the top tube has the ratio of the second to first dimensions of 1.35 to 3.0.

9. The bicycle frame of claim 6, wherein the top tube has a varying cross-section along a length of the top tube, the varying cross-section having the ratio of the second to first dimensions of 1.35 to 3.0, wherein the first dimension is at least 20 mm, and wherein the second dimension is no greater than 60 mm.

10. The bicycle frame of claim 6, wherein the down tube and the vertical tube are coupled to each other at a first junction, wherein the down tube comprises a substantially straight portion forming a majority of a total length of the down tube, and wherein the down tube further comprises a curved portion bending toward said top tube near the first junction.

11. The bicycle frame of claim 10, wherein the mainframe portion further comprises a bottom bracket shell at or near the first junction, the bottom bracket shell including a through-hole extending perpendicular to the plane, the through-hole having a bracket axis extending through a center of the through-hole, and wherein a distance between the bracket axis and a closest point along an imaginary straight line colinear with a longitudinal axis of the substantially straight portion of the down tube is within 20 mm to 100 mm.

12. The bicycle frame of claim 3, wherein the top tube and the down tube are coupled directly or indirectly to each other at a second junction, and wherein the top tube bends toward the down tube as the top tube extends towards the second junction.

13. The bicycle frame of claim 12, wherein the mainframe portion further comprises a head tube configured to connect the top tube to the down tube.

14. The bicycle frame of claim 12, wherein the top tube comprises a substantially straight portion and a curved portion, the curved portion being between the substantially straight portion and the second junction, the curved portion bending toward the down tube as the curved portion extends toward the second junction, and wherein a distance between a center of the cross-section of the curved portion at the second junction and a closest point along an imaginary straight line colinear with a longitudinal axis of the substantially straight portion is between 15 mm and 35 mm.

15. The bicycle frame of claim 3, wherein the mainframe portion further comprises a gusset connected to the top tube and the vertical tube, and wherein the gusset, the top tube, and the vertical tube are arranged to define a second space therebetween.

16. The bicycle frame of claim 15, wherein the top tube and the vertical tube are coupled to each other at a third junction, wherein the gusset is connected to the top tube at a fourth junction, and wherein a distance between the third and fourth junctions is from 20% to 40% of a total length of the top tube.

17. The bicycle frame of claim 16, wherein the distance between the third and fourth junctions is one third of the total length of the top tube.

18. The bicycle frame of claim 15, wherein the top tube and the gusset form an angle of 30° to 55°.

19. The bicycle frame of claim 18, wherein the top tube and the gusset form an angle of 40° to 50°.

20. The bicycle frame of claim 15, wherein the total length of the gusset is 20% to 40% of the total length of the top tube.

21. The bicycle frame of claim 3, further comprising an articulating frame portion which comprises a seat stay including a front end and a rear end, the front end being pivotally connected directly or indirectly to a portion of the mainframe portion where the top tube and the vertical tube are connected to each other.

22. The bicycle frame of claim 21, further comprising a link configured to pivotally connect the front end of the seat stay to the portion of the mainframe portion.

23. The bicycle frame of claim 22, further comprising a shock absorber including a first end and a second end, the first end being connected to the link, the second end being connected to the down tube such that the shock absorber extends generally parallel to the vertical tube.

24. The bicycle frame of claim 23, wherein the articulating frame portion further comprises a chain stay, and wherein the chain stay, the seat stay, and the vertical tube are arranged to define a third space therebetween.

25. The bicycle frame of claim 24, further comprising a fluid reservoir in fluid communication with the shock absorber, the fluid reservoir being mounted on the chain stay or the seat stay.

26. A bicycle frame comprising:
a mainframe portion comprising a first tube, a second tube, and a third tube arranged to define a space therebetween,
wherein the tubes reside generally along a single plane, each tube having a cross-section perpendicular to the plane,
wherein the cross-section of each of the tubes has a first dimension being parallel to the plane, and a second dimension being perpendicular to the plane, and
wherein at least one of the tubes has a substantially constant cross-section along a majority of a total length of the tube, and
wherein the substantially constant cross-section of the tube has a ratio of the second to first dimensions within 1.35 to 3.0.

27. The bicycle frame of claim 26, wherein the ratio of the second to first dimensions is within 1.45 to 3.0.

28. A bicycle frame comprising:
a plurality of tubes interconnected to one another;
wherein the tubes reside generally along a plane, each tube having a cross-sectional height parallel to the plane, and a cross-sectional width perpendicular to the plane,
wherein at least one of the tubes has a ratio of the cross-sectional width to the cross-sectional height within 1.35 to 3.0.

29. The bicycle frame of claim 28, wherein the ratio of the cross-sectional width to the cross-sectional height is within 1.45 to 3.0.

30. A bicycle comprising
a front wheel;
a rear wheel; and
a frame assembly comprising a mainframe and a subframe moveable relative to the mainframe and configured to carry the rear wheel, the mainframe comprising a top tube, a down tube, and a vertical tube arranged to define a space therebetween;
wherein the tubes reside generally along a single plane, each tube having a cross-section perpendicular to the plane,
wherein the cross-section of each of the tubes has a first dimension being parallel to the plane, and a second dimension being perpendicular to the plane, and
wherein at least one of the tubes has a ratio of the second to first dimensions within 1.35 to 3.0.

31. The bicycle of claim 30, wherein the ratio of the second to first dimensions is within 1.45 to 3.0.
